(19) United States
(12) Patent Application Publication
(10) Pub. No.: US 2018/0259047 A1
(43) Pub. Date: Sep. 13, 2018

(54) TORQUE CONVERTER INCLUDING INERTIA RING CONNECTED TO A TURBINE BY A EXTRUDED RIVET WELDLESS CONNECTION

(71) Applicant: Schaeffler Technologies AG & Co. KG, Herzogenaurach (DE)

(72) Inventors: Timothy HESS, Westlake, OH (US); John RAMSEY, Mansfield, OH (US)

(21) Appl. No.: 15/453,648

(22) Filed: Mar. 8, 2017

(51) Int. Cl. F16H 41/28; F16H 45/02; F01D 5/30

(52) U.S. Cl. CPC F16H 41/28; F16H 45/02; F05D 2220/30; F16H 2045/0221; F01D 5/30

(57) ABSTRACT

A torque converter is provided. The torque converter includes a turbine including a turbine shell and a plurality of turbine blades fixed to the turbine shell by tabs of the turbine blades. The turbine shell includes a rounded blade supporting portion supporting the turbine blades. The torque converter also includes an inertia ring and a connector fixing the inertia ring to the turbine shell. Some of the turbine blade tabs fix the connector to the turbine shell. A method of constructing a torque converter is also provided.

The present disclosure relates generally to torque converters and more specifically to the connection of an inertia ring to a turbine in a torque converter.

### BACKGROUND

Inertia rings could potentially be MIG welded to the turbine shell, but MIG welding could produce a weld that protrudes into other components and may need additional processing to machine the weld back. The inertia ring could also potentially be machined from solid as part of the turbine shell, but MFS is not a mass production cost effective design.

### SUMMARY OF THE INVENTION

A torque converter is provided. The torque converter includes a turbine including a turbine shell and a plurality of turbine blades fixed to the turbine shell by tabs of the turbine blades. The turbine shell includes a rounded blade supporting portion supporting the turbine blades. The torque converter also includes an inertia ring and a connector fixing the inertia ring to the turbine shell. Some of the turbine blade tabs fix the connector to the turbine shell. A method of constructing a torque converter is also provided.

A method of constructing a torque converter is also provided. The method includes fixing a connector to an inertia ring; providing a turbine shell including a rounded blade supporting portion including a plurality of circumferentially spaced first slots; aligning second slots of the connector with first slots of the turbine shell; and passing some tabs of turbine blades through the first slots and the second slots to connect the turbine blades and the connector to the rounded blade supporting portion by bending the tabs passed through the first slots and the second slots against an engine-side surface of the connector.

### BRIEF DESCRIPTION OF THE DRAWINGS

The present invention is described below by reference to the following drawings, in which:

FIG. 1 shows a cross-sectional side view of a torque converter according to an embodiment of the present invention; and

FIGS. 2a to 2d show views illustrating how a connection plate of the torque converter is connected to a turbine shell of the torque converter.

### DETAILED DESCRIPTION

The disclosure provides an inertia ring connected to a mounting plate with an extruded rivet. The mounting plate is fixed to the turbine shell by tab rolling.

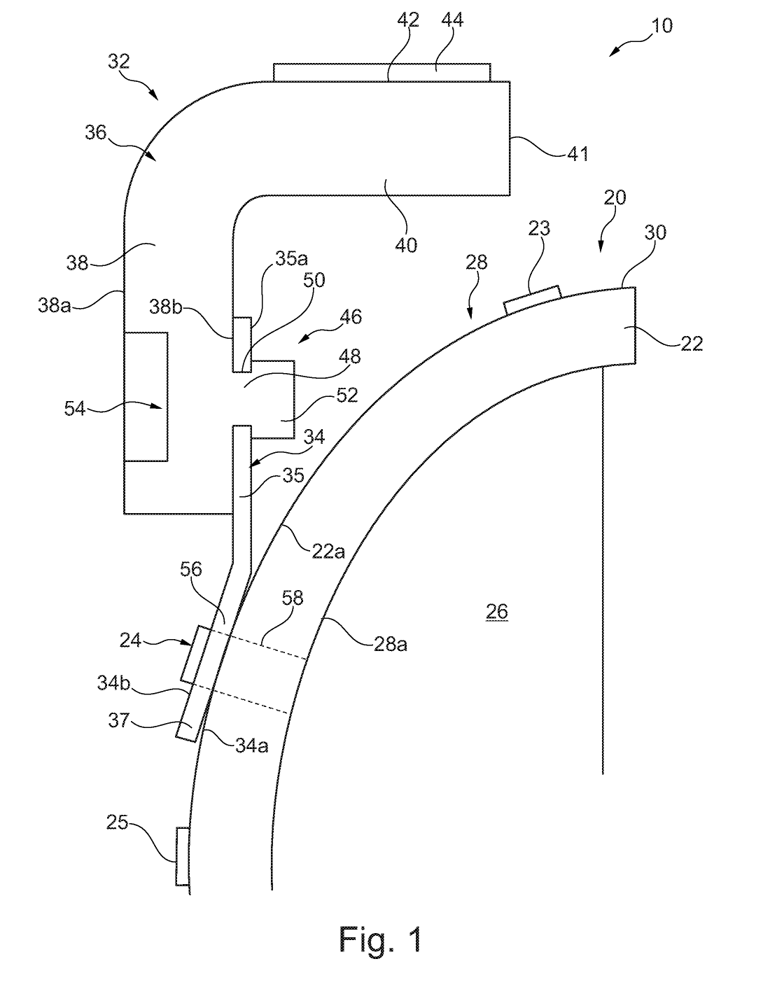

FIG. 1 shows a partial cross-sectional side view of a torque converter 10 in accordance with an embodiment of the present invention. Torque converter 10 is rotatable about a center axis and includes a front cover for connecting to a crankshaft of an internal combustion engine and a rear cover forming a shell of an impeller. The terms axially, radially and circumferentially as used herein are used with respect to the center axis about which torque converter rotates during operation. Torque converter 10 also includes a turbine 20 including a turbine shell 22 and a core ring supporting a plurality of turbine blades 26 therebetween. Blades 26 may be fixed at an engine side thereof to turbine shell 22 by tabs that include radially outer tabs 23, radially inner tabs 25 and intermediate tabs 24 radially between radially inner tabs 25 and the radially outer tabs 23, with intermediate tabs 24 fixing a connector 34 to turbine shell. Although tabs 24 are shown closer radially to tabs 25 than to tabs 23 in FIG. 1, in one preferred embodiment, tabs 25 provided more radially inward than illustrated in FIG. 1 and tabs 25 are spaced radially from tabs 24 approximately the same distance that tabs 23 are spaced from tabs 24. Blades 26 may also be each fixed to core ring at a transmission side thereof by further tabs. Torque converter 10, in a known manner also includes a stator including a plurality of stator blades axially between the turbine and the impeller. During operation, the impeller is rotated via the internal combustion engine, causing the impeller blades to create a fluid flow that drives the turbine blades. The fluid is redirected from the turbine back to the impeller by the stator blades.

Turbine shell 22 includes a rounded blade supporting portion 28, which is shaped as an annular bowl, for contacting engine side edges of turbine blades 26. Blade supporting portion 28 forms and outermost circumference 30 of turbine shell 22. Radially inside of blade supporting portion 28, turbine shell 22 includes an annular inner radial extension that is connected to a damper assembly. The damper assembly, in a known manner, is positioned axially between a radially extending section of the front cover and turbine 20 and is configured for transferring torque from turbine 20 to a transmission input shaft. Torque converter 10 also includes a lockup clutch connected to the damper assembly configured for locking the front cover to turbine 20 via the damper assembly during operation of torque converter 10. The lockup clutch may include a clutch plate and piston that is axially slidable to force the clutch plate into a further surface to lock the lockup clutch.

Torque converter 10 is also provided with an inertia ring 32 that extends radially outside of outermost circumference 30 of turbine shell 22. Inertia ring 32 add inertia to turbine 22 to help NVH during the clutch lockup. Inertia ring 32 is fixed to turbine shell 22 by connector 34, which is in the form of a connection ring. Connection ring 34 is stamped from the same blank as another piece of torque converter 10 and is then formed down to more closely contour an outer surface 22a of turbine 22. More specifically, connection ring 34 includes a radially outer section 35 that extends radially and perpendicular to the center axis of torque converter 10 and a radially inner section 37 that extends at an obtuse angle with respect to outer section 35 to contour to outer surface 22a. Outer section 35 of connection ring 34 is in contact with and connected to inertia ring 32 and inner section 37 of connecting ring 34 is in contact with and connected to outer surface 22a of turbine shell 22.

Inertia ring 32 includes a base 36 having an L-shaped cross-section. Base 36 includes a radially extending ring section 38 that is connected to connection ring 34 and an axially extending ring section 40 extending from an outer circumference of radially extending ring section 38 toward the transmission such that a rim 41 of axially extending ring section 40 is aligned directly radially outside of blade supporting portion 28. As shown in FIG. 1, base 36 is thicker than turbine shell 22 and connection ring 34 is thinner than turbine shell 22. At an outer circumferential surface 42 of ring section 40, inertia ring 34 further includes an inertia mass 44, which is formed as a continuous ring. An entirety of ring section 40 is positioned radially outside of outermost circumference 30 of turbine shell 22.

Radially extending ring section 38 is fixed to connection ring 34 by a plurality of circumferentially spaced extruded rivets 46 that are formed from radially extending section 38. Extruded rivets 46 each include a shaft 48 that extends through a respective hole 50 in outer section 35 of connection ring 34 and a head 52 contacting a turbine-side radially extending surface 35a of outer section 35. A punch may be used to extrude section of ring section 38 to form a plurality of extruded protrusions, leaving an indentation 54 in an engine-side radially extending surface 38a of ring section 38. In a preferred embodiment, the extruded protrusions are extruded during the formation of inertia ring 32 by stamping. The extruded protrusions are then inserted into holes 50 in connection ring 34 and heads 52 are formed by stamping the ends of extruded protrusions that extend out of holes 50. Extruded rivets 46 hold outer section 35 of connection ring 34 against a turbine-side radially extending surface 38b of inner ring section 38.

Connection ring 34 can be made up of ring segments that may or may not form a complete ring. Each segment may have one or more slots 56 for receiving a blade tab 24 and/or holes 50 for fixing to inertia ring 32.

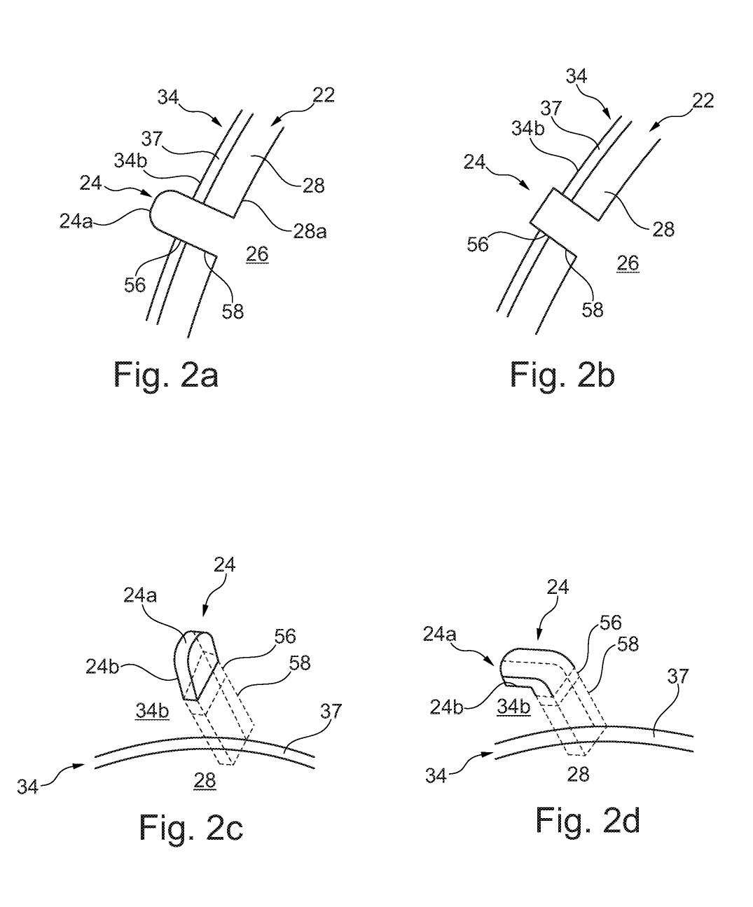

As shown in FIGS. 2a to 2d, in one preferred embodiment, after outer section 35 of connection ring 34 is connected to inertia ring 32 by rivets 46, inner section 37 of connection ring 34 is connected to turbine shell 22 by tabs 24b of turbine blades 26 (and also by tabs 23, 25). Slots 56 formed in radially inner section 37, which are circumferentially spaced from each other about the center axis of torque converter 10, are each aligned with a respective one of slots 58 formed in rounded blade supporting portion 28. Blades 26 are then provided into blade supporting portion 28 such that tabs 24 of blades 26 are each passed through one of slots 58 and one of slots 56. Blades 26 are longer than the combined thicknesses of blade supporting portion 28 and radially inner section 37 such that when blades 26 are flush in contact with a transmission-side surface 28a of blade supporting portion 28, a free end 24a of each tab 24 protrudes past engine-side surface 34b of connection ring 34, as shown in FIGS. 2a, 2b.

Next, tabs 24 are rolled, in the traditionally manner that blades 26 are connected to turbine shell 22, such that tabs 24 are each bent and a free end or tip 24a of each tab 24 is forced toward engine-side surface 34b of connection ring 34 until a planar face 24b of each tab 24 contacts engine-side surface 34b, as shown in FIGS. 2c, 2d. The folding of tabs 24 onto connection plate 34 connects connection ring 34 and inertia ring 32 to turbine shell 22. In this embodiment, free ends 24a of blade tabs 24 extend traverse to engine side surface 34b of inner section 37 before folding and extend along engine-side surface 34b of inner section 37, circumferentially with respect to the center axis of torque converter 10, after folding. The folding of tabs 24 onto connection plate 34 connects connection ring 34 and inertia ring 32 to turbine shell 22, providing a stiff connection. After blades tabs 24 are folded over against engine-side surface 34b of inner section 37, blade tabs 24 may then be brazed to connection ring 34 by applying braze paste between engine-side surface 34b of inner section 37 and the folded free ends of blade tabs 24 to add further stiffness to the connection.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A torque converter comprising:
a turbine including a turbine shell and a plurality of turbine blades fixed to the turbine shell by tabs of the turbine blades, the turbine shell including a rounded blade supporting portion supporting the turbine blades;
an inertia ring; and
a connector fixing the inertia ring to the turbine shell, some of the turbine blade tabs fixing the connector to the turbine shell.

2. The torque converter as recited in claim 1 wherein the connector is a connection ring including a plurality of circumferentially spaced slots passing therethrough that each are aligned with one of a plurality of circumferentially spaced slots passing through the turbine shell, the tabs fixing the connection ring to the turbine shell each passing through one of the slots in the connection ring and one of the slots in the turbine shell and being bent against an engine-side surface of the connection ring.

3. The torque converter as recited in claim 1 wherein the inertia ring includes a base including a radially extending ring section fixed to the connection ring and an axially extending ring section extending from an outer circumference of the radially extending ring section.

4. The torque converter as recited in claim 3 wherein the axially extending ring section is directly radially outside of the rounded blade supporting portion.

5. The torque converter as recited in claim 3 wherein the axially extending ring section is positioned radially outside of an outermost circumferential surface of the turbine shell.

6. The torque converter as recited in claim 1 wherein the connector is a connection ring including a radially outer section fixed against a turbine-side radially extending surface of the inertia ring and a radially inner section fixed against an engine-side surface of the rounded blade supporting portion.

7. The torque converter as recited in claim 6 wherein the radially inner section in angled at an obtuse angle with respect to the radially outer section.

8. The torque converter as recited in claim 6 wherein the inertia ring is fixed to the radially outer section of the connection ring by extruded rivets formed from the inertia ring.

9. The torque converter as recited in claim 1 wherein the tabs include radially inner tabs, radially outer tabs and intermediate tabs radially between the radially inner tabs and the radially outer tabs, the intermediate tabs fixing the connector to the turbine shell.

10. A method of constructing a torque converter comprising:
fixing a connector to an inertia ring;
providing a turbine shell including a rounded blade supporting portion including a plurality of circumferentially spaced first slots;
aligning second slots of the connector with first slots of the turbine shell; and
passing some tabs of turbine blades through the first slots and the second slots to connect the turbine blades and the connector to the rounded blade supporting portion by bending the tabs passed through the first slots and the second slots against an engine-side surface of the connector.

11. The method as recited in claim 10 wherein the inertia ring includes a base including a radially extending ring section fixed to the connector and an axially extending ring section extending from an outer circumference of the radially extending ring section.

12. The method as recited in claim 11 wherein the axially extending ring section is directly radially outside of the rounded blade supporting portion.

13. The method as recited in claim 11 wherein the axially extending ring section is positioned radially outside of an outermost circumferential surface of the turbine shell.

14. The method as recited in claim 10 wherein the connector is a connection ring including a radially outer section fixed against a turbine-side radially extending surface of the inertia ring and a radially inner section fixed against an engine-side surface of the rounded blade supporting portion.

15. The method as recited in claim 14 wherein the radially inner section in angled at an obtuse angle with respect to the radially outer section.

16. The method as recited in claim 14 further comprising extruding protrusions from the inertia ring, the fixing of the inertia ring to the connection ring including passing the extruded protrusions through holes in the radially outer section of the connection ring and then stamping ends of extruded protrusions to form rivet heads.

17. The method as recited in claim 10 wherein the tabs include radially inner tabs, radially outer tabs and intermediate tabs radially between the radially inner tabs and the radially outer tabs, the intermediate tabs fixing the connector to the turbine shell
